(19) United States
(12) Patent Application Publication
(10) Pub. No.: US 2026/0310489 A1
(43) Pub. Date: Oct. 8, 2026

(54) DELAY OPERATIONS IN PROCESSOR CORES FOR POWER IMPROVEMENTS

(71) Applicant: QUALCOMM Incorporated, San Diego, CA (US)

(72) Inventors: Dinesh Kumar CHOUDHARY, Tonk (IN); Sai Sneha Venkata YESANTARAO, Hyderabad (IN); Sai Sumanth MANCHUKONDA, Rangareddy (IN); Maulik SHAH, Hyderabad (IN)

(21) Appl. No.: 19/172,010

(22) Filed: Apr. 7, 2025

(51) Int. Cl. G06F 9/48; G06F 1/08; G06F 1/3296

(52) U.S. Cl. CPC G06F 9/4837; G06F 1/08; G06F 1/3296

(57) ABSTRACT

Aspects of the disclosure are directed to delay operations in processor cores. In accordance with one aspect, the disclosure includes enabling a timer interrupt associated with a delay value; configuring a low power mode (LPM) based on the delay value; executing an idle state entry sequence based on the LPM to transition from an operational state to an idle state; and firing an interrupt signal after a timer expiration.

### TECHNICAL FIELD

This disclosure relates generally to the field of information processing systems, and, in particular, to delay operations in processor cores within an information processing system.

### BACKGROUND

An information processing system with a plurality of processor cores and memory devices may operate in different operational modes, depending on the current service demand. One operational mode incorporates controlled delays in processor execution. One form of controlled delays utilizes busy loops which consume unnecessary dc power. A more power-efficient mechanism for incorporating controlled delays may be desired for the plurality of processor cores.

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, the disclosure provides delay operations in processor cores. Accordingly, the present disclosure discloses a method including: enabling a timer interrupt associated with a delay value; configuring a low power mode (LPM) based on the delay value; executing an idle state entry sequence based on the LPM to transition from an operational state to an idle state; and firing an interrupt signal after a timer expiration.

Another aspect of the disclosure provides an apparatus including: a non-transitory memory configured to store a delay value; and a processor coupled to the non-transitory memory, the processor configured to program a low power mode (LPM) based on the delay value and to execute an idle state entry sequence based on the LPM to transition from an operational state to an idle state.

Another aspect of the disclosure provides a non-transitory computer-readable medium storing computer executable code, operable on a device including at least one processor and at least one memory coupled to the at least one processor, wherein the at least one processor is configured to implement a delay operation, the computer executable code including: instructions for causing a computer to enable a timer interrupt associated with a delay value; instructions for causing the computer to configure a low power mode (LPM) based on the delay value; instructions for causing the computer to execute an idle state entry sequence based on the LPM to transition from an operational state to an idle state; and instructions for causing the computer to fire an interrupt signal after a timer expiration.

These and other aspects of the present disclosure will become more fully understood upon a review of the detailed description, which follows. Other aspects, features, and implementations of the present disclosure will become apparent to those of ordinary skill in the art, upon reviewing the following description of specific, exemplary implementations of the present invention in conjunction with the accompanying figures. While features of the present invention may be discussed relative to certain implementations and figures below, all implementations of the present invention can include one or more of the advantageous features discussed herein. In other words, while one or more implementations may be discussed as having certain advantageous features, one or more of such features may also be used in accordance with the various implementations of the invention discussed herein. In similar fashion, while exemplary implementations may be discussed below as device, system, or method implementations it should be understood that such exemplary implementations can be implemented in various devices, systems, and methods.

### BRIEF DESCRIPTION OF THE DRAWINGS

FIG. 1 illustrates an example information processing system.

FIG. 2 illustrates an example busy loop firmware code.

FIG. 3 illustrates an example of a first delay implementation.

FIG. 4 illustrates an example of a second delay implementation.

FIG. 5 illustrates an example of a third delay implementation.

FIG. 6 illustrates an example comparison of dc power consumption.

FIG. 7 illustrates an example of a summary graph of dc power consumption for different idle states of a plurality of processor cores.

FIG. 8 illustrates an example of a summary graph of dc power savings for different idle states of a plurality of processor cores.

FIG. 9 illustrates an example of a delay implementation flow diagram for a plurality of processor cores.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

An information processing system, for example, a computing system with multiple slices (e.g., processing engines) or a system on a chip (SoC), uses multiple levels of coordination or synchronization. In one example, a slice may include a processing engine (i.e., a subset of the computing system) as well as associated memory units and other peripheral devices. In one example, execution of an application may be decomposed into a workload which is executed by multiple slices or multiple processing engines. A plurality of processor cores may be part of each processing engine where a processor core is an independent processing element which may be operated in parallel with other processor cores.

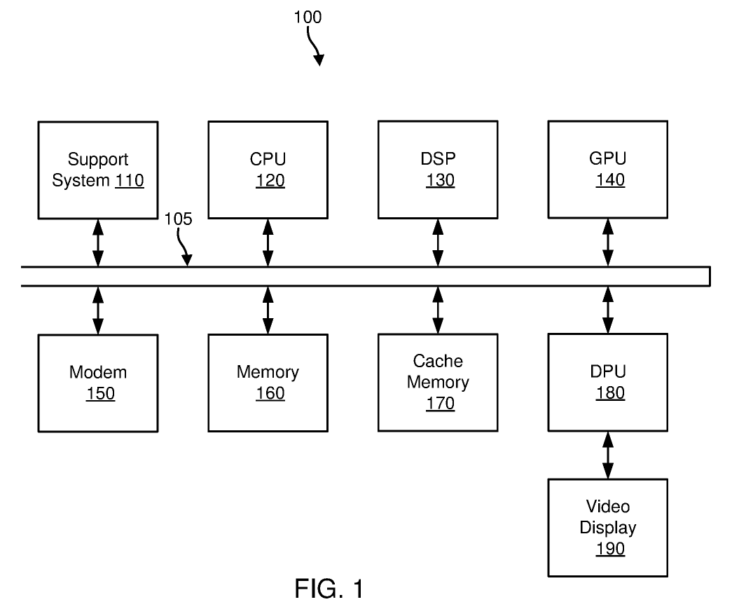

FIG. 1 illustrates an example information processing system 100. In one example, the information processing system 100 includes a plurality of processing engines such as a central processing unit (CPU) 120, a digital signal processor (DSP) 130, a graphics processing unit (GPU) 140, a display processing unit (DPU) 180, etc. In one example, various other functions in the information processing system 100 may be included such as a support system 110, a modem 150, a memory 160, a cache memory 170 and a video display 190. For example, the plurality of processing engines and various other functions may be interconnected by an interconnection databus 105 to transport data and control information. In one example, the CPU 120 may serve as a controller or a microcontroller of other processing engines. In one example, the controller or microcontroller may reallocate tasks from one processing engine to another. In one example, the controller or microcontroller may determine if a baseline workload partition should be reallocated using machine learning (ML) monitoring of system on a chip (SOC) temperatures.

In one example, the memory 160 and/or the cache memory 170 may be shared among the CPU 120, the GPU 140 and the other processing engines. In one example, the CPU 120 may include a first internal memory which is not shared with the other processing engines. In one example, the GPU 140 may include a second internal memory which is not shared with the other processing engines. In one example, any processing engine of the plurality of processing engines may have an internal memory (i.e., a dedicated memory) which is not shared with the other processing engines. Although several components of the information processing system 100 are included herein, one skilled in the art would understand that the components listed herein are examples and are not exclusive. Thus, other components may be included as part of the information processing system 100 within the spirit and scope of the present disclosure.

In one example, one or more processing engines in the information processing system 100 may be aggregated into a single integrated circuit known as a system on a chip (SOC). In one example, the SOC may include the central processing unit (CPU) 120 and other processing engines such as the DSP 130 or the GPU 140. The SOC may also include the memory 160 and the cache memory 170.

In one example, the information processing system 100 may be part of a wireless device in a wireless communication system. For example, the wireless communication system may conform to a wireless network protocol such as 4G LTE (long term evolution), 5G NR (new radio), etc.

In one example, for certain operational scenarios where a plurality of tasks is executed, it may be preferable to delay or halt processor core execution depending on device constraints (e.g., silicon characteristics). In one example, delayed processor core execution may be applicable for operational scenarios such as enablement of a clock or head switch or power supplies, enablement of a plurality of registers in a sequence, propagation of a reset signal across a plurality of hardware modules.

In one example, a processor core execution delay or halt may have a time duration of a few clock cycles up to several hundred milliseconds or greater than one second, dependent on device recommendations. In one example, the processor core execution delay or halt may be implemented as a plurality of busy loops which has significant dc power leakage even when the processor core is not executing operational tasks. For example, a busy loop is a recursive operation which repeatedly polls for an event occurrence. For example, the busy loop is an inactive operation which unnecessarily consumes dc power.

In one example, some advanced processor architectures may include context-retaining idle states which may be used in lieu of busy loops to introduce processor core execution delays. For example, a context-retaining idle state preserves a processor core state while in an idle state (i.e., a non-execution state). In one example, the context-retaining idle state has a timeline ranging from microseconds to milliseconds for a busy loop to be translated to an idle state window for dc power savings.

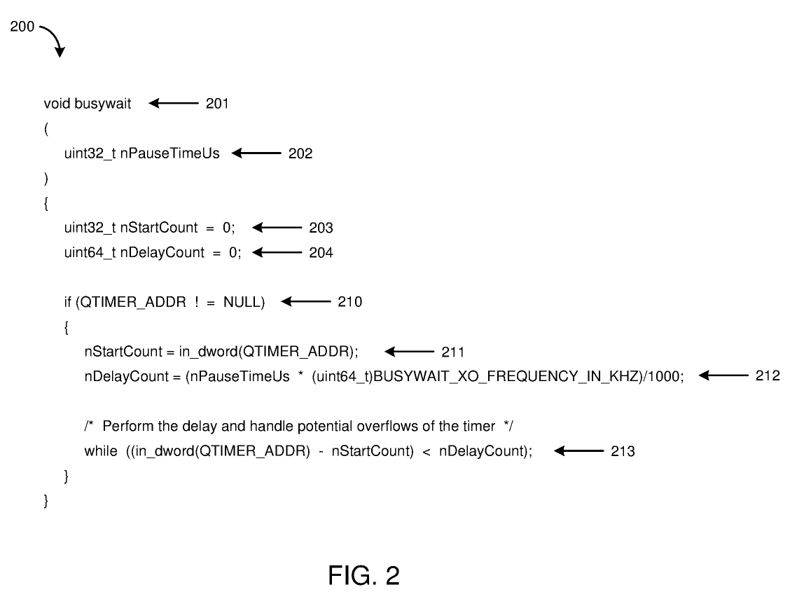

FIG. 2 illustrates an example busy loop firmware code 200. In one example, the example busy loop firmware code 200 includes a busywait title 201. In one example, an unsigned 32 bit integer named nPauseTimeUs 202 is defined, an unsigned 32 bit integer named nStartCount 203 is initialized to zero and an unsigned 64 bit integer named nDelayCount 204 is initialized to zero. In one example, a busy loop 210 includes a setting of the nStartCount 203 to a stored value 211 and a setting of the nDelayCount 204 to a computed value 212 until a count 213 reaches the nDelayCount 204.

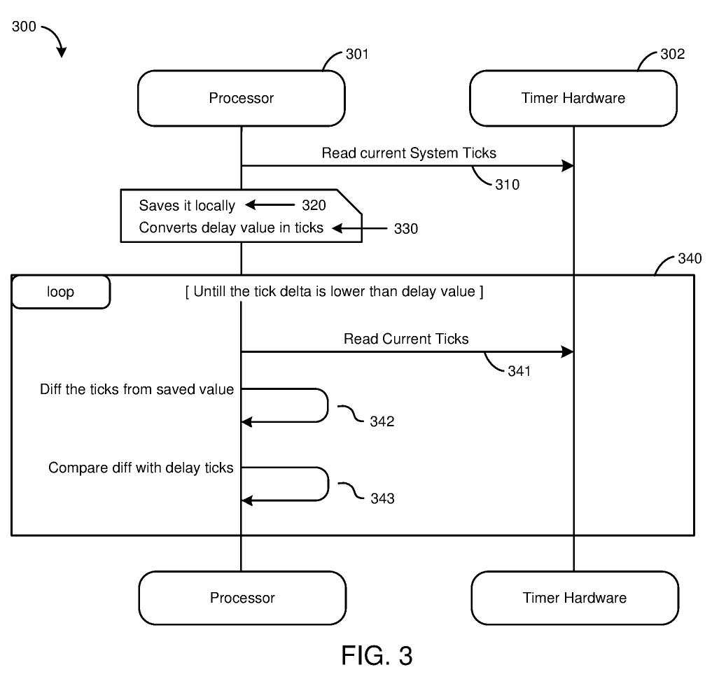

FIG. 3 illustrates an example of a first delay implementation 300. In one example, the first delay implementation 300 includes a processor 301 and a timer hardware 302. In one example, the first delay implementation 300 commences with a read of current system ticks (i.e., clock count) 310 from the timer hardware 302. Next, the processor 301 saves the current system ticks into local memory 320 and converts a delay value into system ticks (i.e., clock cycles) 330. Next, a busy loop 340 commences by the processor 301 where a read of updated ticks 341 is performed on the timer hardware 302, a difference between the updated ticks and the saved current system ticks is computed 342 and the difference is compared with a delay ticks threshold 343. If the difference is less than the delay ticks threshold 343, the busy loop 340 continues. Otherwise, the busy loop 340 terminates and is complete.

In one example, the first delay implementation 300 may be used for multicore enablement when a plurality of hardware registers is sequentially written (e.g., on a time scale < 10 usec), for propagation reset to different system hardware (e.g., on a time scale approximately 100 usec), for establishing secure systems from a trust zone (e.g., on a time scale approximately 100 msec or for different polling (e.g., system control and management interface (SCMI) responses) or hardware completions (e.g., on a time scale approximately 100 msec).

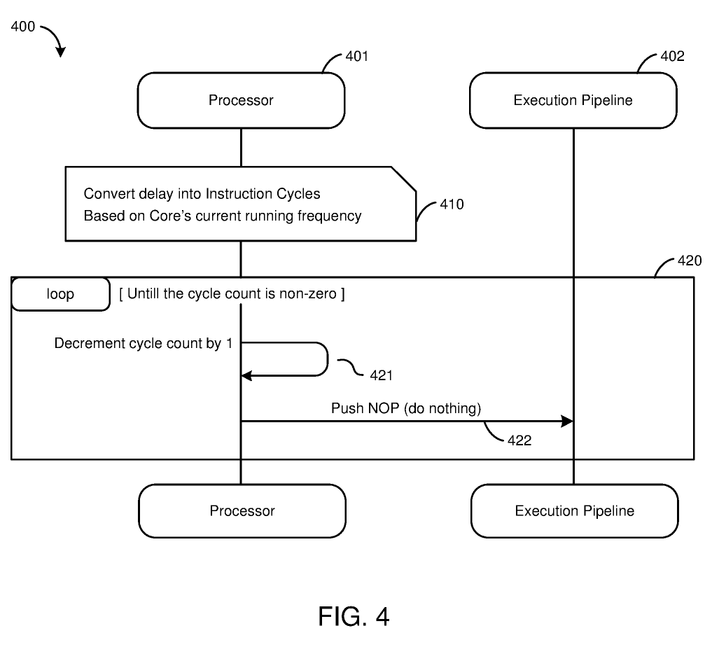

FIG. 4 illustrates an example of a second delay implementation 400. In one example, the second delay implementation 400 includes a processor 401 and an execution pipeline 402. In one example, the second delay implementation 400 commences with a conversion of delay into instruction cycles 410 by the processor 401. In one example, the conversion is based on a processor core’s current operational frequency. Next, a busy loop 420 commences by the processor 401 where a cycle count is decremented by one 421 by the processor 401. Next, the processor 401 pushes a no operation (NOP) instruction 422 to the execution pipeline 402 is complete. In one example, blocks 421 and 422 are repeated until the cycle count is zero.

In one example, the second delay implementation 400 is vulnerable to an inaccurate delay if the operational frequency is changed (e.g., from 1 GHz to 2 GHz) due to independent dynamic clock voltage scaling (DCVS) operation. In one example, the processor 401 is always running due the execution of the busy loop 420 which results in wasted dc power.

In one example, a delay implementation may employ a sequence of instructions including a Wait for Event Timeout (WFET) instruction, a clock gating with timeout (WFIT) instruction, etc. In one example, the WFET instruction is a wait for event with timeout. For example, the WFET instruction is a hint instruction where a processor may remain in a low-power state until an event occurs. In one example, the WFIT instruction is a wait for interrupt with timeout instruction. For example, the WFIT instruction is a clock gating with timeout instruction which puts a processor into a low-power state until an event occurs. In one example, the sequence of instructions is equivalent to a clock gating (e.g., C2) mode with a per processor core timer configured to generate a wakeup and embedded into a processor core architecture. In one example, the sequence of instructions may be provisioned further for a delay-based intelligence idle state selection for dc power savings. In one example, the clock gating mode gates (i.e., halts) a clock signal to certain processor functions while leaving voltage/current supplies intact.

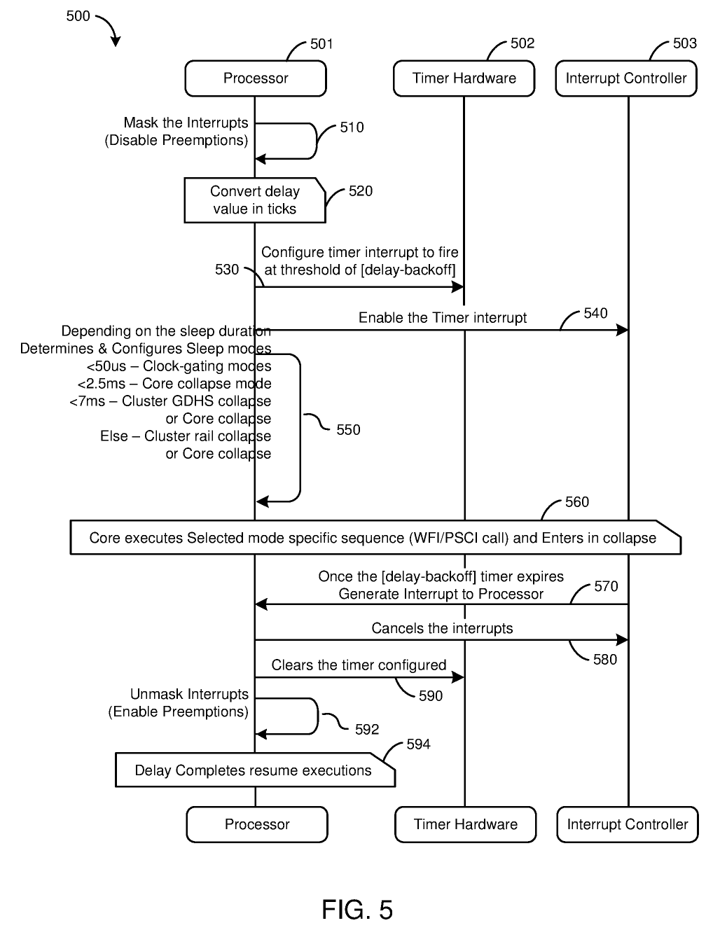

FIG. 5 illustrates an example of a third delay implementation 500. In one example, the third delay implementation 500 includes a processor 501, a timer hardware 502 and an interrupt controller 503. In one example, the third delay implementation 500 commences with masking interrupts (i.e., disabling preemptions) 510 by the processor 501. In one example, masking interrupts avoid a context switch in the processor to minimize dc power transients and consumption.

Next, a delay value is converted into system ticks (i.e., clock cycles) 520 (e.g., microseconds) by the processor 501.Next, the processor 501 configures the timer hardware 502 with a timer value which is enabled at a threshold value equal to the delay value 530. Next, the processor 501 enables the timer interrupt 540. In one example, the timer interrupt is enabled in the interrupt controller 503.

Next, the processor 501 configures a low power mode (LPM) based on the delay value 550. In one example, the LPM is set to a clock gating mode if the delay value is less than 50 microseconds. In one example, the LPM is set to a core collapse mode if the delay value is less than 2.5 ms and not less than 50 microseconds. In one example, the LPM is set to a partial power gating cluster collapse mode if only one processor core is active in the cluster and if the delay value is less than 7 ms and not less than 2.5 ms; else the LPM is set to the core collapse mode. In one example, the LPM is set to a rail collapse mode if only one processor core is active in the cluster and the delay is at least 7 ms; else the LPM is set to the core collapse mode.

Next, the processor 501 executes the configured LPM with a specific LPM instruction sequence (e.g., a wait for interrupt/power state coordination interface (WFI/PSCI) call) and enters an idle state 560. Next, the interrupt controller 503 generates an interrupt and sends the interrupt 570 to the processor 501 after the timer interrupt expires. Next, the processor 501 cancels the interrupt 580 to the interrupt controller 503. Next, the processor 501 clears the timer value 590 at the timer hardware 502. Next, the processor 501 unmasks the interrupt 592 (e.g., enables preemptions). Finally, the processor 501 resumes normal execution after the delay is completed 594.

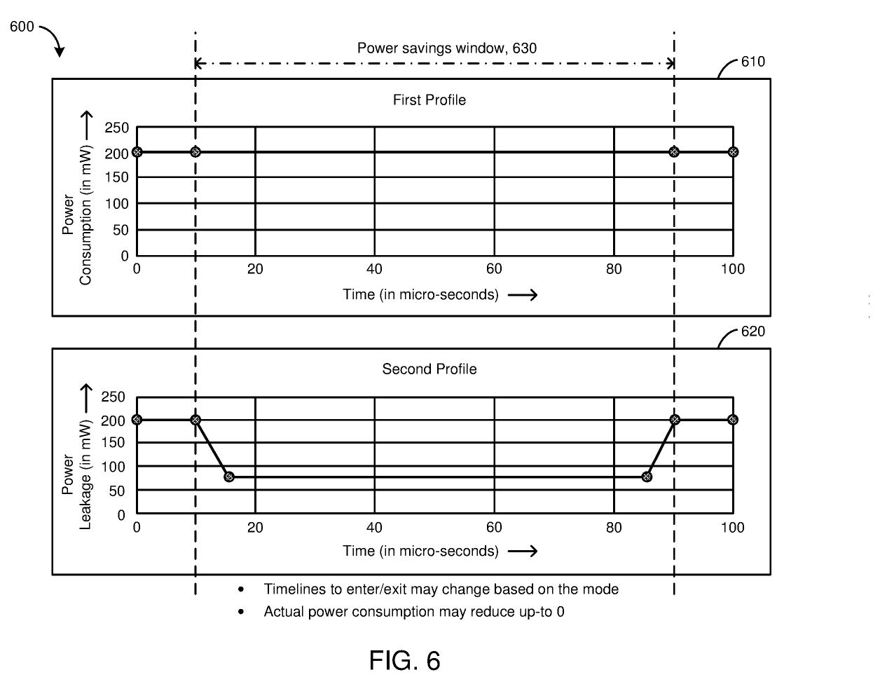

FIG. 6 illustrates an example comparison of dc power consumption 600. In one example, the comparison of dc power consumption 600 includes a first dc power consumption profile 610 and a second dc power consumption profile 620. In one example, the first dc power consumption profile 610 corresponds to a first delay implementation 300 where dc power consumption remains constant at 200 mW over a 100 microsecond time interval. In one example, the second dc power consumption profile 620 corresponds to the third delay implementation 500 where dc power consumption decreases to approximately 80 mW during a power savings window 630 over a 80 microsecond time interval.

In one example, a timeline to enter and to exit the power savings window may depend on selection of an LPM mode. For example, dc power consumption may be zero during the power savings window in some scenarios.

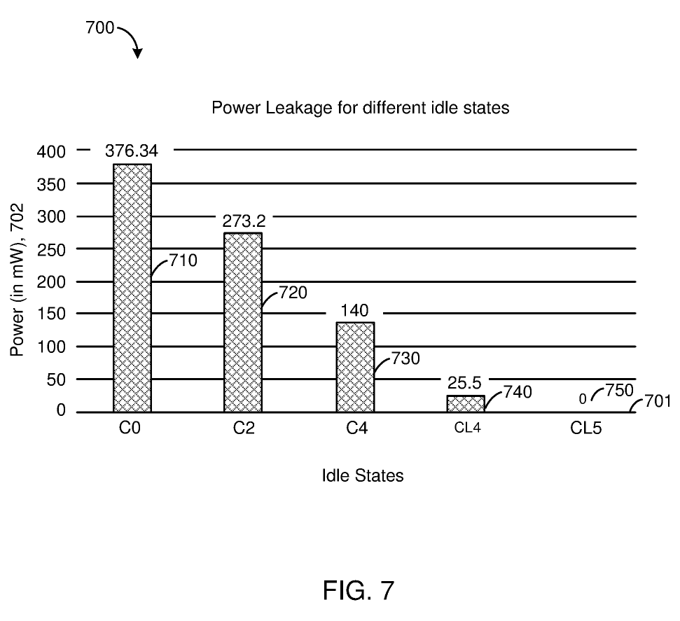

FIG. 7 illustrates an example of a summary graph 700 of dc power consumption for different idle states of a plurality of processor cores. FIG. 7 shows a horizontal axis 701 for idle states and a vertical axis 702 for dc power leakage in milliwatts. In one example, the summary graph 700 includes an execution state 710 with a dc power leakage of 376.34 mW, a clock-gated state 720 with a dc power leakage of 273.2 mW, a core collapse state 730 with a dc power leakage of 140 mW, a cluster collapse state 740 with a dc power leakage of 25.5 mW and a rail collapse state 750 with a dc power leakage of 0 mW.

In one example, depending on an idle window, there is an opportunity for up to 100% dc power leakage reduction for the plurality of processor cores. For example, the clock-gated state is an optimal mode for an idle window < 560 microseconds. For example, the core collapse state is an optimal mode for an idle window < 2.5 milliseconds. For example, the cluster collapse state is an optimal mode for an idle window < 7 milliseconds. For example, the rail collapse state is an optimal mode for an idle window greater than or equal to 7 milliseconds. In one example, these values are exemplary and may vary depending on hardware evolution.

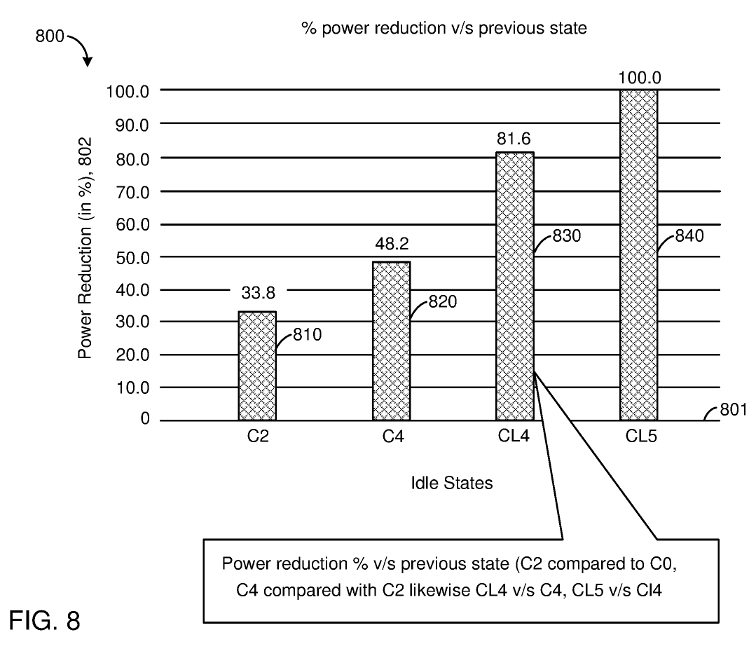

FIG. 8 illustrates an example of a summary graph 800 of dc power savings for different idle states of a plurality of processor cores. FIG. 8 shows a horizontal axis 801 for idle states and a vertical axis 802 for dc power reduction in percentage. In one example, the summary graph 800 includes a clock-gated state 810 with a dc power savings of 33.8%, a core collapse state 820 with a dc power savings of 48.2%, a cluster collapse state 830 with a dc power savings of 81.6% and a rail collapse state 840 with a dc power savings of 100.0%.

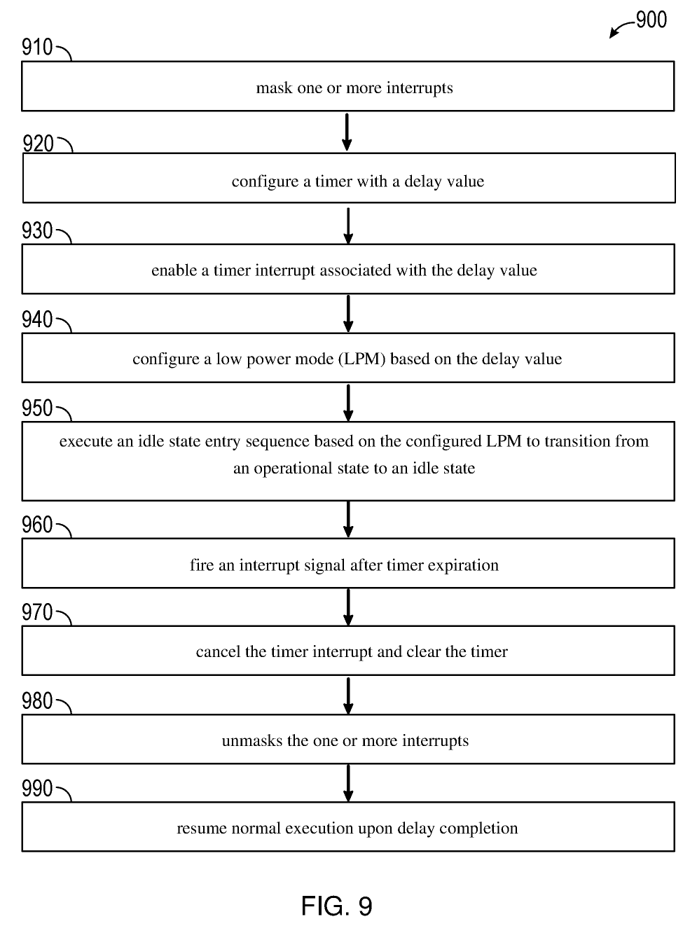

FIG. 9 illustrates an example of a delay implementation flow diagram 900 for a plurality of processor cores. In block 910, mask one or more interrupts. In one example, the one or more interrupts are masked. In one example, masking the one or more interrupts include one or more disabling preemptions. In one example, masking the one or more interrupts is performed by a processor. In one example, the processor includes a plurality of processor cores. In one example, a cluster is a plurality of processors. In one example, the step of block 910 is performed by one or more of the following: a processor, a micro-processor, a processing engine, a central processing unit (CPU), a graphics processing unit (GPU), a digital signal processor (DSP), a microcontroller, a controller, etc.

In block 920, configure a timer with a delay value. In one example, a timer is configured with a delay value. In one example, the timer is an execution-level specific timer. In one example, the delay value is converted into clock ticks (e.g., clock cycles). In one example, the execution-level specific timer may be selected based on an execution level (e.g., user space, kernel, hypervisor, trusted environment, secure applications, etc.). In one example, the delay value establishes a threshold value for an interrupt signal firing. In one example, the configuring is performed by the processor. In one example, the timer is included in a timer hardware. In one example, the timer hardware includes an oscillator coupled to a time counter. In one example, the step of block 920 is performed by one or more of the following: a timer hardware, a processor, a micro-processor, a processing engine, a central processing unit (CPU), a graphics processing unit (GPU), a digital signal processor (DSP), a microcontroller, a controller, etc.

In block 930, enable a timer interrupt associated with the delay value. In one example, a timer interrupt associated with the delay value is enabled. In one example, the timer interrupt fires a interrupt signal upon expiration of the timer. In one example, the timer interrupt is executed by the processor. In one example, the timer interrupt is enabled in an interrupt controller. In one example, the interrupt controller is coupled to the timer. In one example, the interrupt controller is hosted on a hardware state machine or a control hardware. In one example, the step of block 930 is performed by one or more of the following: a timer hardware, a processor, a micro-processor, a processing engine, a central processing unit (CPU), a graphics processing unit (GPU), a digital signal processor (DSP), a microcontroller, a controller, etc.

In block 940, configure a low power mode (LPM) based on the delay value. In one example, a low power mode (LPM) is configured based on the delay value. In one example, the LPM is selected among a clock gating mode, a core collapse mode, a partial power gating cluster collapse mode or a cluster rail collapse mode. In one example, the clock-gating mode disables a clock signal to halt processor operations. In one example, the core collapse mode disables a power supply to halt a processor core. In one example, the partial power gating cluster collapse mode disables a power supply to halt a cluster of processors. In one example, the cluster rail collapse mode disables a power supply rail to halt the cluster of processors. In one example, the LPM selection is based on the delay value relative to a plurality of delay thresholds. In one example, the step of block 940 is performed by one or more of the following: a timer hardware, a processor, a micro-processor, a processing engine, a central processing unit (CPU), a graphics processing unit (GPU), a digital signal processor (DSP), a microcontroller, a controller, etc.

In block 950, execute an idle state entry sequence based on the LPM to transition from an operational state to an idle state. In one example, an idle state entry sequence is executed based on the LPM to transition from an operational state to an idle state. In one example, the idle state includes a power collapse for dc power savings. In one example, the idle state is the clock gating mode, the core collapse mode, the partial power gating cluster collapse mode, or the cluster rail collapse mode. In one example, the entry sequence may include a wait for interrupt (WFI) call. In one example, the entry sequence may include a power state coordination interface (PSCI) call. In one example, the idle state entry sequence is coordinated by the processor and executed by the timer hardware and the interrupt controller. In one example, the step of block 950 is performed by one or more of the following: a timer hardware, interrupt controller, etc.

In block 960, fire an interrupt signal after a timer expiration. In one example, to fire an interrupt signal means to trigger the interrupt signal. In one example, an interrupt signal is fired after a timer expiration. In one example, the timer expiration occurs when the timer reaches the delay value. In one example, the interrupt signal is generated by the interrupt controller and sent to the processor. In one example, the step of block 960 is performed by one or more of the following: an interrupt controller, a microcontroller, a control hardware, etc.

In block 970, cancel the timer interrupt and clear the timer. In one example, the timer interrupt is canceled and the timer is cleared. In one example, the timer interrupt cancellation resets a timer-interrupt line in the interrupt controller. In one example, the timer clearing resets the timer to zero. In one example, the step of block 970 is performed by one or more of the following: a timer hardware, an oscillator, a time counter, etc.

In block 980, unmasks the one or more interrupts. In one example, the one or more interrupts are unmasked. In one example, unmasking the one or more interrupts includes enabling preemptions. In one example, unmasking the one or more interrupts is performed by the processor. In one example, the step of block 980 is performed by one or more of the following: a processor, a micro-processor, a processing engine, a central processing unit (CPU), a graphics processing unit (GPU), a digital signal processor (DSP), a microcontroller, a controller, etc.

In block 990, resume normal execution upon delay completion. In one example, normal execution is resumed upon delay completion. In one example, the normal execution is performed by the processor. In one example, the step of block 990 is performed by one or more of the following: a timer hardware, a processor, a micro-processor, a processing engine, a central processing unit (CPU), a graphics processing unit (GPU), a digital signal processor (DSP), a microcontroller, a controller, etc.

In one example, the present disclosure discloses a method including: enabling a timer interrupt associated with a delay value; configuring a low power mode (LPM) based on the delay value; executing an idle state entry sequence based on the LPM to transition from an operational state to an idle state; and firing an interrupt signal after a timer expiration.

In one example, the method further includes converting the delay value to clock ticks. In one example, the delay value establishes a threshold value for the firing the interrupt signal. In one example, the idle state includes a power collapse for dc power savings. In one example, the idle state is one of the following: a clock gating mode, a core collapse mode, a partial power gating cluster collapse mode, or a cluster rail collapse mode.

In one example, the method further includes canceling the timer interrupt; and clearing a timer. In one example, the method further includes selecting the LPM from among one of the following: a clock gating mode, a core collapse mode, a partial power gating cluster collapse mode or a cluster rail collapse mode. In one example, the method further includes unmasking one or more interrupts. In one example, the one or more interrupts include one or more disabling preemptions.

In one example, the method further includes resuming normal execution upon delay completion. In one example, the method further includes configuring the timer with the delay value. In one example, the method further includes masking the one or more interrupts. In one example, the one or more interrupts include one or more disabling preemptions.

In one example, the present disclosure discloses an apparatus including: a non-transitory memory configured to store a delay value; and a processor coupled to the non-transitory memory, the processor configured to program a low power mode (LPM) based on the delay value and to execute an idle state entry sequence based on the LPM to transition from an operational state to an idle state.

In one example, the apparatus further includes a timer hardware coupled to the processor, the timer hardware configured to program a timer with the delay value. In one example, the apparatus further includes an interrupt controller coupled to the processor, the interrupt controller configured to enable a timer interrupt associated with the delay value. In one example, the interrupt controller is further configured to fire an interrupt signal after a timer expiration.

In one example, the present disclosure discloses a non-transitory computer-readable medium storing computer executable code, operable on a device including at least one processor and at least one memory coupled to the at least one processor, wherein the at least one processor is configured to implement a delay operation, the computer executable code including: instructions for causing a computer to enable a timer interrupt associated with a delay value; instructions for causing the computer to configure a low power mode (LPM) based on the delay value; instructions for causing the computer to execute an idle state entry sequence based on the LPM to transition from an operational state to an idle state; and instructions for causing the computer to fire an interrupt signal after a timer expiration.

In one example, the non-transitory computer-readable medium further includes instructions for causing the computer to configure a timer with the delay value. In one example, the non-transitory computer-readable medium further includes instructions for causing the computer to cancel the timer interrupt; and instructions for causing the computer to clear the timer.

In one aspect, one or more of the steps for providing delay operations in processor cores in FIG. 9 may be executed by one or more processors which may include hardware, software, firmware, etc. The one or more processors, for example, may be used to execute software or firmware needed to perform the steps in the flow diagram of FIG. 9. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may reside in a processing system, external to the processing system, or distributed across multiple entities including the processing system. The computer-readable medium may be embodied in a computer program product. By way of example, a computer program product may include a computer-readable medium in packaging materials. The computer-readable medium may include software or firmware. Those skilled in the art will recognize how best to implement the described functionality presented throughout this disclosure depending on the particular application and the overall design constraints imposed on the overall system.

Any circuitry included in the processor(s) is merely provided as an example, and other means for carrying out the described functions may be included within various aspects of the present disclosure, including but not limited to the instructions stored in the computer-readable medium, or any other suitable apparatus or means described herein, and utilizing, for example, the processes and/or algorithms described herein in relation to the example flow diagram.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in the figures may be rearranged and/or combined into a single component, step, feature or function or embodied in several components, steps, or functions. Additional elements, components, steps, and/or functions may also be added without departing from novel features disclosed herein. The apparatus, devices, and/or components illustrated in the figures may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

One skilled in the art would understand that various features of different embodiments may be combined or modified and still be within the spirit and scope of the present disclosure.

What is claimed is:

1. A method comprising:
enabling a timer interrupt associated with a delay value;
configuring a low power mode (LPM) based on the delay value;
executing an idle state entry sequence based on the LPM to transition from an operational state to an idle state; and
firing an interrupt signal after a timer expiration.

2. The method of claim 1, further comprising converting the delay value to clock ticks.

3. The method of claim 1, wherein the delay value establishes a threshold value for the firing the interrupt signal.

4. The method of claim 1, wherein the idle state includes a power collapse for dc power savings.

5. The method of claim 1, further comprising:
canceling the timer interrupt; and
clearing a timer.

6. The method of claim 5, further comprising selecting the LPM from among one of the following: a clock gating mode, a core collapse mode, a partial power gating cluster collapse mode or a cluster rail collapse mode.

7. The method of claim 5, further comprising unmasking one or more interrupts.

8. The method of claim 7, wherein the one or more interrupts include one or more disabling preemptions.

9. The method of claim 7, wherein the idle state is one of the following: a clock gating mode, a core collapse mode, a partial power gating cluster collapse mode, or a cluster rail collapse mode.

10. The method of claim 7, further comprising resuming normal execution upon delay completion.

11. The method of claim 7, further comprising configuring the timer with the delay value.

12. The method of claim 11, further comprising masking the one or more interrupts.

13. The method of claim 12, wherein the one or more interrupts include one or more disabling preemptions.

14. An apparatus comprising:
a non-transitory memory configured to store a delay value; and
a processor coupled to the non-transitory memory, the processor configured to program a low power mode (LPM) based on the delay value and to execute an idle state entry sequence based on the LPM to transition from an operational state to an idle state.

15. The apparatus of claim 14, further comprising a timer hardware coupled to the processor, the timer hardware configured to configure a timer with the delay value.

16. The apparatus of claim 15, further comprising an interrupt controller coupled to the processor, the interrupt controller configured to enable a timer interrupt associated with the delay value.

17. The apparatus of claim 16, wherein the interrupt controller is further configured to fire an interrupt signal after a timer expiration.

18. A non-transitory computer-readable medium storing computer executable code, operable on a device comprising at least one processor and at least one memory coupled to the at least one processor, wherein the at least one processor is configured to implement a delay operation, the computer executable code comprising:
instructions for causing a computer to enable a timer interrupt associated with a delay value;
instructions for causing the computer to configure a low power mode (LPM) based on the delay value;
instructions for causing the computer to execute an idle state entry sequence based on the LPM to transition from an operational state to an idle state; and
instructions for causing the computer to fire an interrupt signal after a timer expiration.

19. The non-transitory computer-readable medium of claim 18, further comprising instructions for causing the computer to configure a timer with the delay value.

20. The non-transitory computer-readable medium of claim 19, further comprising:
instructions for causing the computer to cancel the timer interrupt; and
instructions for causing the computer to clear the timer.
